(19) United States
(12) Patent Application Publication
(10) Pub. No.: US 2025/0226607 A1
(43) Pub. Date: Jul. 10, 2025

(54) Conductive Terminal, Housing and Connector

(71) Applicant: Tyco Electronics (Shanghai) Co., Ltd., Shanghai (CN)

(72) Inventors: Xinxin (Daisy) Li, Shanghai (CN); Liming (Eric) Wang, Shanghai (CN); Zebin (Donnie) Tang, Shanghai (CN); Zhenyu (Richard) Chen, Shanghai (CN); Yang (Leon) Zou, Shanghai (CN); Feng (Will) Chen, Shanghai (CN)

(73) Assignee: Tyco Electronics (Shanghai) Co., Ltd., Shanghai (CN)

(21) Appl. No.: 19/008,809

(22) Filed: Jan. 3, 2025

(30) Foreign Application Priority Data
Jan. 5, 2024 (CN) 202410021042.7

(51) Int. Cl. H01R 13/432; H01R 11/11

(52) U.S. Cl. CPC H01R 13/432; H01R 11/11

(57) ABSTRACT

A conductive terminal adapted for mating installation in a housing includes a terminal body. The terminal body has a cable end adapted to be terminated to a wire, a mating end adapted to mate with the housing, and a bending portion defined proximate the mating end. The bending portion has a locking element arranged at a top thereof. The locking element is adapted to mate with the housing such that the conductive terminal and the housing are locked together.

### CROSS-REFERENCE TO RELATED APPLICATION

This application claims the benefit of Chinese Patent Application No. CN 202410021042.7 filed on Jan. 5, 2024 in the State Intellectual Property Office of China, the whole disclosure of which is incorporated herein by reference.

### FIELD OF THE DISCLOSURE

The disclosure relates to the field of connectors, and more particularly, to a conductive terminal, a housing, and a connector.

### BACKGROUND OF THE INVENTION

In the prior art, when a conductive terminal is inserted into a housing, a locking mechanism may be required to accommodate the conductive terminal in a proper position in the housing and prevent it from withdrawing from the housing to achieve a reliable electrical connection. For example, the prior art discloses a locking mechanism which is provided inside a bottom surface of a housing to prevent a terminal from withdrawing from the housing. However, when a conductive terminal is inserted into this housing, the locking mechanism is obscured from view as it is arranged at the bottom of the housing. Thus, it is not easy for a user to determine whether the conductive terminal is properly inserted and locked in place.

Consequently, there is need for a connector including an improved conductive terminal as well as a corresponding housing.

### SUMMARY OF THE INVENTION

According to an embodiment of the present disclosure, a conductive terminal adapted for mating installation in a housing includes a terminal body. The terminal body has a cable end adapted to be terminated to a wire, a mating end adapted to mate with the housing, and a bending portion defined proximate the mating end. The bending portion has a locking element arranged at a top thereof. The locking element is adapted to mate with the housing to lock the conductive terminal and the housing together.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is a perspective view of an example conductive terminal according to embodiments of the disclosure.

FIG. 2 is a perspective view of an example housing according to embodiments of the disclosure.

FIG. 3 is a perspective view of an example connector including the conductive terminal of FIG. 1 and the housing of FIG. 2 according to embodiments of the disclosure.

FIG. 4 is a perspective view of another example conductive terminal according to embodiments of the disclosure.

FIG. 5 is a perspective view of another example housing according to embodiments of the disclosure.

FIG. 6 is a perspective view of another example connector including the conductive terminal of FIG. 4 and the housing of FIG. 5 according to embodiments of the disclosure.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As mentioned above, according to connectors of the prior art, when a conductive terminal is inserted into a housing of the connector, a locking mechanism will be obscured from view if the locking mechanism is arranged at the bottom of the housing and/or terminal. Thus, it is not easy for a user to check whether the conductive terminal is inserted in place and locked in place within the housing.

In view of the above problems, the present disclosure provides a conductive terminal and a housing that each have a locking mechanism arranged at or toward a top thereof, and a connector including such a conductive terminal and a housing. Specifically, a locking hole is arranged at the top of one of the conductive terminal and the housing, and a locking element is arranged at the top of the other of the terminal and the housing. When the conductive terminal is inserted into the housing, the locking element is fitted into the locking hole to achieve locking between the housing and the conductive terminal. As locking occurs proximate a top of the connector, housing and/or terminal, it can be easily observed. In addition, by biasing the top of the conductive terminal, the locking element can be released from the locking hole to achieve unlocking between the housing and the conductive terminal. Such unlocking can also be easily observed.

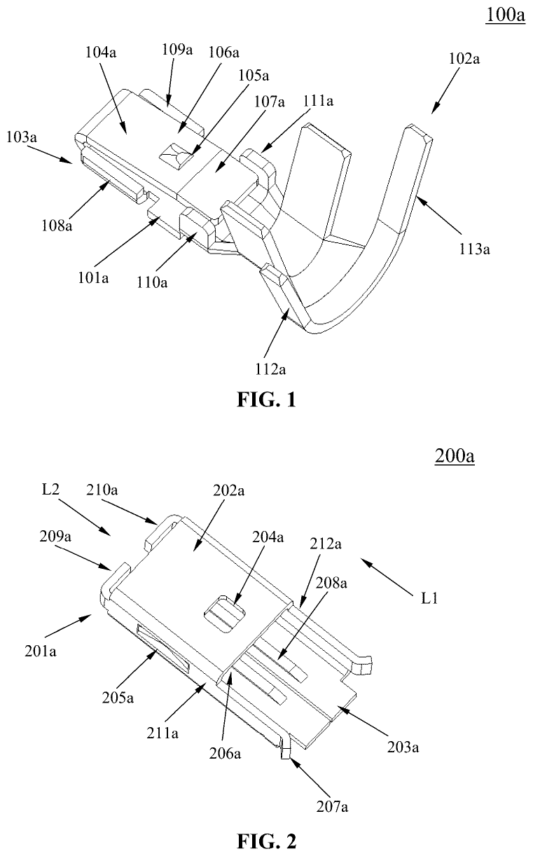

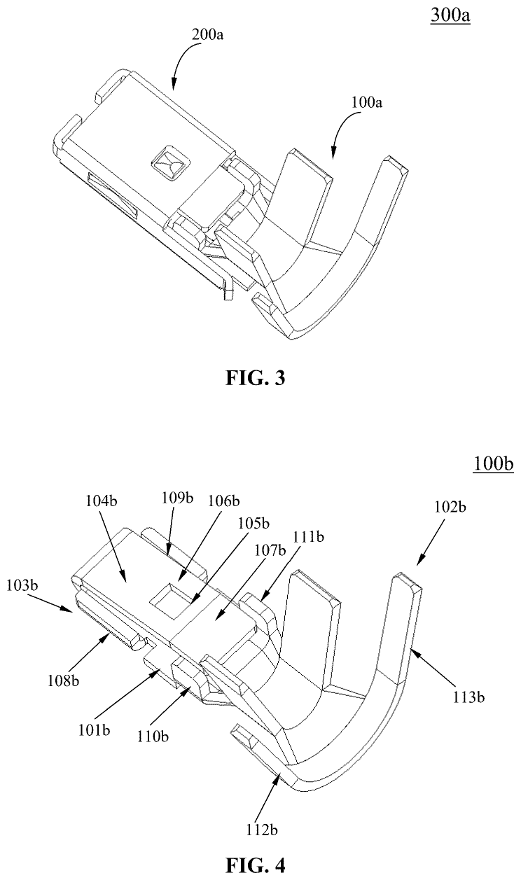

Referring generally to FIGS. 1-3, an embodiment of a connector is shown, in which a locking hole is disposed at the top of a housing and a locking element is disposed at the top of a conductive terminal. More specifically, FIG. 1 illustrates a perspective view of an example conductive terminal 100a according to embodiments of the disclosure. FIG. 2 illustrates a perspective view of an example housing 200a according to embodiments of the disclosure. FIG. 3 illustrates a perspective view of an example connector 300a including the conductive terminal of FIG. 1 and the housing of FIG. 2.

As shown in FIG. 1, the conductive terminal 100a includes a terminal body 101a extending between a cable end 102a and a mating end 103a. The cable end 102a is configured to be terminated to a wire (e.g., a conductive wire such as a cable or an electric wire). The mating end 103a is configured to mate with a housing (e.g., the housing 200a of FIG. 2 or a similar housing, etc.). For example, the mating end 103a of the conductive terminal 100a is arranged near the front of the terminal body 101a, and the cable end 102a is arranged near the rear of the terminal body 101a. The terminal body 101a includes a bending portion 104a at the mating end 103a, and the top 106a of the bending portion 104a has a protruding locking element 105a. The locking element 105a is adapted to mate with the housing such that the conductive terminal 100a is locked with the housing together and the locking element 105a is exposed from the housing.

As shown in FIG. 2, the housing 200a includes a body 201a. The body 201a has a receiving cavity 206a for receiving a conductive terminal (e.g., the conductive terminal 100a of FIG. 1 or a similar conductive terminal, etc.), and the top 202a of the body 201a has a locking hole 204a extending to the receiving cavity 206a. The locking hole 204a is adapted to cooperate with a bending portion of a conductive terminal (e.g., the conductive terminal 100a of FIG. 1 or a similar conductive terminal, etc.) to lock the conductive terminal with the housing 200a together and expose part of the bending portion of the conductive terminal.

As shown in FIG. 3, the connector 300a includes the conductive terminal 100a of FIG. 1 and the housing 200a of FIG. 2 for mating installation with the conductive terminal 100a. The locking element 105a at the top 106a of the conductive terminal 100a is adapted to mate with the locking hole 204a at the top 202a of the housing 200a, such that the conductive terminal 100a and the housing 200a are locked together, and the locking element 105a is exposed from the locking hole 204a. For example, at least a portion of the mating end 103a of the conductive terminal 100a can be inserted into the receiving cavity 206a along a first direction L1 (i.e., a normal insertion direction of the conductive terminal) as shown in FIG. 2, such that the locking element 105a is fitted (e.g., snap-fit, etc.) in the locking hole 204a to achieve visible locking. It should be understood that the locking element 105a is not limited to the form of the locking protrusion of FIG. 1, and can also have other forms, such as a locking elastic arm (e.g., an integrated elastic arm or separate elastic arms), etc.

According to the conductive terminal 100a of FIG. 1, the housing 200a of FIG. 2, and the connector 300a of FIG. 3, the conductive terminal can mate with the housing to achieve a connector with visible locking. It is convenient for a user to check whether the conductive terminal is inserted in place and locked in place when the conductive terminal is inserted into the housing, thereby improving user experience, and locking efficiency.

In the example of FIG. 1, the bending portion 104a can be formed by reversely bending an end of the terminal body 101a being away from the cable end 102a at an angle greater than 90 degrees (e.g., 180 degrees or other angles), for example, reversely bending from the bottom of the terminal body 101a or in other ways. For example, the conductive terminal 100a can be generally V-shaped, U-shaped, or other various shapes after the reverse bending. For example, the reverse bending of the conductive terminal 100a can easily form a longer bending portion 104a, to provide sufficient contacting between the housing and the conductive terminal 100a when they are in contact. In addition, the bending portion 104a can be elastic to provide sufficient elastic force when the housing and the conductive terminal 100a are in compression contact, so that they are in full contact and a stable electrical connection is achieved.

In the example of FIG. 1, the conductive terminal 100a may further include limiting parts 110a, 111a extending from at least one of the two sides of the terminal body 101a to restrict the movement of at least a portion of the bending portion 104a in the housing. For example, the limiting part may be located on at least one side of the bending portion. As shown in FIG. 1 and FIG. 3, the limiting parts 110a, 111a are arranged at the mating end 103a. When the conductive terminal 100a is inserted into the housing 200a along the first direction L1, the top 106a can be restricted from moving further along the first direction L1 in the receiving cavity 206a of the housing 200a, thereby preventing the conductive terminal 100a from being over-inserted into the housing 200a. For example, at least a portion of the top 106a (e.g., an end 107a of the top 106a) is not inserted into the receiving cavity 206a, and a portion of the top 106a located in front of the end 107a is restricted from moving further in the receiving cavity 206a along the first direction L1. As shown in FIG. 1 and FIG. 3, at least one of the limiting parts 110a, 111a can extend upward from the side of the terminal body 101a to a height, so that the (top) height of at least one of the limiting parts 110a, 111a is higher than the (top) height of the housing 200a or the receiving cavity 206a when the conductive terminal 100a is inserted into the housing 200a. In addition, the limiting parts 110a, 111a can facilitate a user to hold the conductive terminal when performing locking or unlocking between the conductive terminal 100a and the housing 200a, so as to operate the conductive terminal more reliably.

In the example of FIG. 1, at least a portion of the top 106a of the bending portion 104a (e.g., the end 107a of the top 106a) may be adapted to be biased to release the locking connection between the conductive terminal 100a and the housing 200a. For example, the top 106a of the bending portion 104a may be adapted to be elastically deformed. When the conductive terminal 100a is inserted into the housing 200a (e.g., along the first direction L1), the end 107a can be biased downward. While the locking element 105a is aligned with the locking hole 204a of the housing 200a, the downward biasing is released to cause the top 106a to bounce upward, such that the locking element 105a is received in the locking hole 204a to lock the conductive terminal 100a and the housing 200a together, and to prevent the conductive terminal 100a from withdrawing from the housing 200a, thereby achieving a stable and secure connection. When the conductive terminal 100a and the housing 200a are locked together, the end 107a can be biased downward to release the locking connection, and the conductive terminal 100a can be withdrawn from the housing 200a (e.g., along a second direction L2 opposite to the first direction L1, i.e., a normal withdrawal direction of the conductive terminal). As such, visible locking/unlocking can be conveniently achieved, thereby improving user experience and locking/unlocking efficiency. In some examples, the end 107a of the top 106a can be disposed at an angle relative to other part of the top 106a. For example, the end 107a may be generally horizontal, and the other part of the top 106a extends obliquely relative to the end 107a.

In the example of FIG. 1, the conductive terminal 100a may further include expansion parts 108a, 109a extending from at least one of the two sides of the terminal body 101a, and the expansion parts 108a, 109a may be adapted to cooperate with the housing 200a such that the conductive terminal 100a is clamped in the housing 200a. For example, the expansion part may be located on at least one side of the bending portion. For example, the expansion parts 108a, 109a may extend outward from both sides of the terminal body 101a to contact or engage with the side wall of the receiving cavity 206a of the housing 200a to clamp the conductive terminal 100a (e.g., at least a portion of the mating end 103a) in the receiving cavity 206a, thereby achieving a secure connection. As shown in FIG. 1, the limiting parts 110a, 111a are located between the expansion parts 108a, 109a and the components at the cable end.

The cable end 102a is configured to be terminated to a wire. In the example of FIG. 1, the cable end 102 constitutes a crimping portion configured to be crimped to an end of a wire. The terminal body 101a includes one or more sets of crimping arms 112a, 113a at the cable end 102a. The crimping arm can initially be formed into an open state that defines a channel. Any number of sets of crimping arms 112a, 113a can be provided. During manufacturing, the crimping arms 112a, 113a are crimped to a wire through a crimping process. In an alternative embodiment, the cable end 102a can be terminated to the wire by an alternative device, which is not limited herein. For example, the cable end 102a can include a cylindrical portion for crimping or can be soldered to the wire, etc.

In the example of FIG. 2, the housing 200a may further include one or more protruding ribs 208a (two ribs are shown in the figure, which is for illustration only and not for limitation) arranged on the inner wall of the bottom 203a of the body 201a. The ribs 208a may be adapted to cooperate with (e.g., contact or engage with, etc.) the bottom of the conductive terminal 100a (e.g., the bottom of the terminal body 101a). As a result, line-contacting rather than surface-contacting can be achieved between the conductive terminal 100a and the housing 200a, and the contacting is more secure and reliable since the contacting area between the conductive terminal and the housing is smaller. For example, at least one of the one or more ribs 208a may extend into the receiving cavity 206a. For example, at least one rib 208a may be completely arranged within the receiving cavity 206a, or may be partially arranged inside the receiving cavity 206a and partially arranged outside the receiving cavity 206a. Optionally, the bottom of the terminal body 101a of the conductive terminal 100a may have a groove matched with the rib 208 to provide additional guidance when the conductive terminal 100a enters or exits the housing 200a. Alternatively, the bottom of the terminal body 101a of the conductive terminal 100a may be substantially flat.

In the example of FIG. 2, the housing 200a may further include two opposite side portions 211a, 212a located between the top 202a and the bottom 203a of the body 201a. One end of at least one of the two side portions 211a, 212a can be expanded and extended outward to form a guiding structure 207a. As such, the guiding structure 207a can form a tapered opening to provide guiding effect when the conductive terminal 100a enters or exits the housing 200a.

At least one of the two side portions 211a, 212a is provided with a clamping portion 205a that is recessed inwardly. The clamping portion 205a may be adapted to clamp the conductive terminal 100a when the conductive terminal 100a is received in the receiving cavity 206a. For example, the clamping portion 205a may have a form of an elastic arm. As the mating end of the conductive terminal 100a is inserted into the receiving cavity 206a of the housing 200a, the clamping portion 205a may expand outwardly and clamp the conductive terminal 100a (e.g., the expansion parts 108a, 109a).

In the example of FIG. 2, the housing 200a may further include blocking portions 209a, 210a, which are located between the top 202a and the bottom 203a of the body 201a and are disposed adjacent to one end of the receiving cavity 206a. For example, a first end of the receiving 206a may be provided with blocking portions 209a, 210a. These prevent the conductive terminal 100a from being excessively inserted and withdrawn from the first end of the receiving cavity 206a when the conductive terminal 100a is inserted from an opening at a second end of the receiving cavity 206a along the first direction L1. In addition, the blocking portions 209a, 210a may also prevent the conductive terminal 100a from being inserted into the receiving cavity 206a along the second direction L2 to avoid an erroneous insertion operation.

In the example of FIG. 2, the blocking portions 209a and 210a can be formed by extending inward from the two side portions 211a and 212a near one end of the receiving cavity 206a. In other examples, the blocking portions can also be formed by extending upward from the bottom 203a of the housing 200a near one end of the receiving cavity 206a.

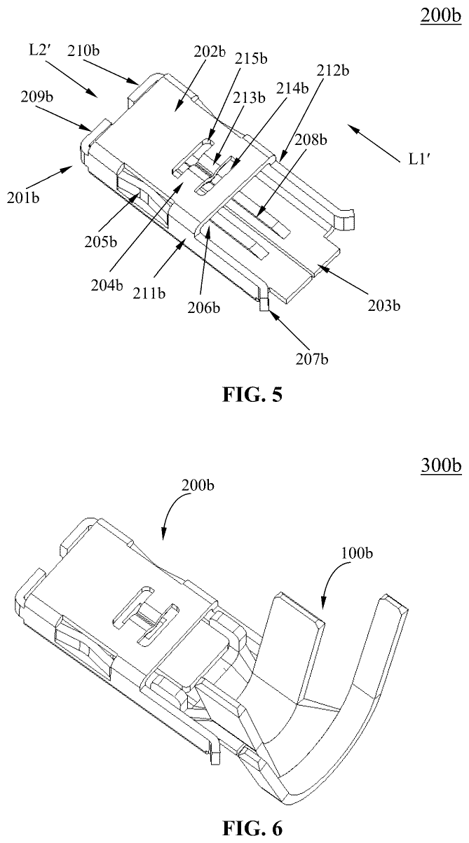

Referring to FIGS. 4-6, an embodiment of a connector is shown in which a locking hole is disposed at the top of a conductive terminal and a locking element is disposed at the top of a housing. FIG. 4 illustrates a perspective view of another example conductive terminal 100b according to embodiments of the disclosure. FIG. 5 illustrates a perspective view of another example housing 200b according to embodiments of the disclosure. FIG. 6 illustrates a perspective view of another example connector 300b including the conductive terminal 100b of FIG. 4 and the housing 200b of FIG. 5.

As shown in FIG. 4, the conductive terminal 100b includes a terminal body 101b extending between a cable end 102b and a mating end 103b. The cable end 102b is configured to be terminated to a wire (e.g., a conductive wire such as a cable or an electric wire), and the mating end 103b is configured to mate with a housing (e.g., the housing 200b of FIG. 5 or a similar housing, etc.). For example, the mating end 103b of the conductive terminal 100b is arranged near the front of the terminal body 101b, and the cable end 102b is arranged near the rear of the terminal body 101b. The terminal body 101b includes a mating portion 104b located at the mating end 103b, and the top 106a of the mating portion 104b has a locking hole 105b. The locking hole 105b is adapted to mate with the housing and partially exposed from the housing to lock the conductive terminal 100a and the housing together.

As shown in FIG. 5, the housing 200b includes a body 201b. The body 201b has a receiving cavity 206b for receiving a conductive terminal (e.g., the conductive terminal 100b of FIG. 4 or a similar conductive terminal, etc.), and the top 202b of the body 201b has an opening 204b extending to the receiving cavity 206b. The opening 204b defines a locking element 213b extending toward the receiving cavity 206b. The locking element 213b is adapted to cooperate with the top of the conductive terminal (e.g., the conductive terminal 100b of FIG. 4 or a similar conductive terminal, etc.) to lock the conductive terminal with the housing 200b together and expose the mating portion at the top of the conductive terminal from the opening 204b.

As shown in FIG. 6, the connector 300b includes the conductive terminal 100b of FIG. 4 and the housing 200b of FIG. 5 for mating installation with the conductive terminal 100b. The locking element 213b at the top 202b of the housing 200b is adapted to mate with the locking hole 105b at the top 106b of the conductive terminal 100b, such that the conductive terminal 100b and the housing 200b are locked together, and part of the locking hole 105b is exposed from the opening 204b. For example, at least a portion of the mating end 103b of the conductive terminal 100b can be inserted into the receiving cavity 206b along a first direction L1′ (i.e., a normal insertion direction of the conductive terminal) as shown in FIG. 4, such that the locking element 213b is fitted (e.g., snap-fitted, etc.) in the locking hole 105b, and at least a portion of the locking hole 105b is exposed from the opening 204b, so as to achieve visible locking. It should be understood that the locking element 213b is not limited to the locking protrusion of FIG. 1, but may also have other forms, such as a locking elastic arm (e.g., an integrated elastic arm or separate elastic arms), etc.

For example, the opening 204b may define holes 214b, 215b extending to the receiving cavity 206b on at least one side of the locking element 213b, so as to expose at least a portion of the locking hole 105b when the locking element 213b is fitted in the locking hole 105b. In the example of FIG. 5, the opening 204b is shown as a transverse “I” shape. It should be understood that the opening 204b may also be a transverse “T” shape (e.g., one side defines an exposed hole), or other various shapes suitable for exposing the locking hole 105b (e.g., a longitudinal “I” shape, “T” shape, etc.), which is not limited herein.

According to the conductive terminal 100b of FIG. 4, the housing 200b of FIG. 5, and the connector 300b of FIG. 6, the conductive terminal can mate with the housing to achieve a connector with visible locking. It is convenient for a user to check whether the conductive terminal is inserted in place and locked in place when the conductive terminal is inserted into the housing, thereby improving user experience, and locking efficiency.

In the example of FIG. 4, similar to the bending portion 104a described above with respect to FIG. 1, the mating portion 104b can be formed by reversely bending an end of the terminal body 101b being away from the cable end 102b at an angle greater than 90 degrees (e.g., 180 degrees or other angles). In other examples, the mating portion 104b can also be formed in other ways, which is not limited herein. For example, the top 105b of the mating portion 104b can be elastic to provide sufficient elastic force when the housing and the conductive terminal 100b are in compression contact, so that they are in full contact and a stable electrical connection is achieved.

In the example of FIG. 4, similar to the limiting parts 110a, 111a described above with respect to FIG. 1, the conductive terminal 100b may further include limiting parts 110b, 111b extending from at least one of the two sides of the terminal body 101b to restrict the movement of at least a portion of the mating portion 104b in the housing. For example, the limiting part may be located on at least one side of the mating portion.

Similar to at least a portion of the top 106a of the bending portion 104a described above with respect to FIG. 1 (e.g., the end 107a of the top 106a), at least a portion of the top 106b of the mating portion 104b (e.g., the end 107b of the top 106b) may be adapted to be biased to release the locking connection between the conductive terminal 100b and the housing 200b. For example, the top 106b of the mating portion 104b may be adapted to be elastically deformed. When the conductive terminal 100b is inserted into the housing 200b (e.g., along the first direction L1′), the end 107b may be biased downward. While the locking element 213b is aligned with the locking hole 105b of the conductive terminal 100b, the downward bias is released to cause the top 106b to bounce upward, such that the locking element 213b is received in the locking hole 105b to lock the conductive terminal 100b and the housing 200b together, and to prevent the conductive terminal 100b from withdrawing from the housing 200b, thereby achieving a stable and secure connection. When the conductive terminal 100b and the housing 200b are locked together, the end 107b can be biased downward to release the locking connection and allow the conductive terminal 100b to be withdrawn from the housing 200b (e.g., along a second direction L2′ opposite to the first direction L1′, i.e., a normal withdrawal direction of the conductive terminal).

In the example of FIG. 4, similar to the expansion parts 108a, 109a described above with respect to FIG. 1, the conductive terminal 100b may further include expansion parts 108b, 109b extending from at least one of the two sides of the terminal body 101b, and the expansion parts 108b, 109b may be adapted to cooperate with the housing 200b such that the conductive terminal 100b is clamped in the housing 200b. For example, the expansion part may be located on at least one side of the mating portion. The cable end 102b of FIG. 4 is similar to the cable end 102a of FIG. 1 and will not be described in detail.

In the example of FIG. 5, similar to the rib 208a described above with respect to FIG. 2, the housing 200b may further include one or more protruding ribs 208b (two ribs are shown in the figure, which is for illustration only and not limitation) arranged on the inner wall of the bottom 203b of the body 201b. The ribs 208b may be adapted to cooperate with (e.g., contact or engage with, etc.) the bottom of the conductive terminal 100b (e.g., the bottom of the terminal body 101b), which will not be described in detail.

In the example of FIG. 5, the housing 200b may further include two opposite side portions 211b, 212b located between the top 202b and the bottom 203b of the body 201b. The housing 200b may have a guiding structure 207b similar to the guiding structure 207a described above with respect to FIG. 2, wherein the guiding structure 207b is formed on at least one side portion 211b, 212b, which will not be described in detail.

The housing 200b may have a clamping portion 205b similar to the clamping portion described above with respect to FIG. 2, wherein the clamping portion 205b is formed on at least one side portion 211b, 212b, which will not be described in detail. The housing 200b may have blocking portions 209b, 210b formed similarly to the blocking portions 209a, 210a described above with respect to FIG. 2, which is not described in detail.

As shown in FIGS. 1-6, in the illustrated embodiments, the entire conductive terminals 100a, 100b, and housings 200a, 200b may be a single metal component made of a single metal sheet. For example, a single metal sheet can be made into the conductive terminal 100a of FIG. 1, the conductive terminal 100b of FIG. 4, the housing 200a of FIG. 2, and the housing 200b of FIG. 5 through processes such as stamping, bending or the like.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A conductive terminal adapted for mating installation in a housing, comprising:
a terminal body, including:
a cable end adapted to be terminated to a wire;
a mating end adapted to mate with the housing; and
a bending portion defined proximate the mating end and having a locking element arranged at a top of the bending portion of terminal body, the locking element adapted to mate with the housing such that the conductive terminal and the housing are locked together.

2. The conductive terminal according to claim 1, wherein the bending portion is defined by a reversely bent end of the terminal body opposite from the cable end, the bending portion bent at an angle greater than 90 degrees.

3. The conductive terminal according to claim 1, further comprising a limiting part extending from at least one of two sides of the terminal body and adapted to restrict at least a portion of the top of the bending portion from moving in the housing.

4. The conductive terminal according to claim 1, wherein at least a portion of the top of the bending portion is adapted to be biased to release a locking connection between the conductive terminal and the housing.

5. The conductive terminal according to claim 1, further comprising an expansion part extending from at least one of two sides of the terminal body, the expansion part adapted to cooperate with the housing such that the conductive terminal is clamped in the housing.

6. The conductive terminal according to claim 1, wherein the locking element comprises a the locking hole is adapted to mate with or receive a locking protrusion of housing to lock the conductive terminal and the housing together.

7. The conductive terminal according to claim 1, wherein the locking element comprises a locking protrusion adapted to mate with the housing such that the conductive terminal and the housing are locked together.

8. A housing adapted for mating installation with a conductive terminal, comprising:
a body having a receiving cavity for receiving the conductive terminal, a top of the body defining a locking element proximate the receiving cavity, the locking element adapted to cooperate with a bending portion of the conductive terminal to lock the conductive terminal and the housing together.

9. The housing according to claim 8, wherein one or more protruding ribs are provided on an inner wall of a bottom of the body, the one or more ribs adapted to cooperate with a bottom of the conductive terminal.

10. The housing according to claim 8, wherein at least one of the one or more ribs extends into the receiving cavity.

11. The housing according to claim 8, further comprising two opposite side portions located between the top of the body and a bottom of the body, an end of at least one of the two side portions expands and extends outward to form a guiding structure.

12. The housing according to claim 8, further comprising two opposite side portions located between the top of the body and a bottom of the body, at least one of the two side portions includes a clamping portion that is recessed inwardly and is adapted to clamp the conductive terminal when the conductive terminal is received in the receiving cavity.

13. The housing according to claim 8, further comprising a blocking portion located between the top of the body and a bottom of the body and disposed adjacent to an end of the receiving cavity, the blocking portion is adapted to restrict the conductive terminal from being removed or introduced into the housing from the end of the receiving cavity.

14. The housing according to claim 8, wherein the locking element comprises a locking hole opening into the receiving cavity.

15. The housing according to claim 8, wherein the locking element comprises a protruding locking element extending into the receiving cavity.

16. A connector adapted to connect to a wire, comprising:
a housing having a receiving cavity, a top of the housing defining a first locking element proximate the receiving cavity;
a conductive terminal including a terminal body having:
a cable end adapted to be terminated to the wire;
a mating end adapted to mate with the housing; and
a bending portion defined proximate the mating end and having a second locking element arranged at a top of the bending portion of the terminal body, the second locking element adapted to mate with the first locking element of the housing such that the conductive terminal and the housing are locked together.

17. The connector accordingly to claim 16, wherein:
the first locking element includes a locking hole formed through the housing; and
the second locking element includes a protruding locking element received within the locking hold for locking the housing and the conductive terminal together.

18. The connector accordingly to claim 18, wherein the protruding locking element is exposed through the locking hole of the housing.

19. The connector accordingly to claim 16, wherein:
the first locking element includes a protruding locking element extending into the receiving cavity; and
the second locking element includes a locking hole receiving the protruding locking element for locking the housing and the conductive terminal together.

20. The connector accordingly to claim 19, wherein the protruding locking element is exposed through the locking hole of the conductive terminal.
